(19) United States
(12) Patent Application Publication
(10) Pub. No.: US 2007/0118879 A1
(43) Pub. Date: May 24, 2007

(54) SECURITY PROTOCOL MODEL FOR UBIQUITOUS NETWORKS

(75) Inventor: Chan-Yeob Yeun, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/533,728

(22) Filed: Sep. 20, 2006

(30) Foreign Application Priority Data
Sep. 20, 2005 (KR) 10-2005-0087462

(51) Int. Cl. H04L 9/32

(52) U.S. Cl. 726/3

(57) ABSTRACT

Gaining secure access to a ubiquitous network by detecting a user joining one particular network domain of the ubiquitous network, authenticating the joined user by employing symmetric key authentication together with a single sign-on mechanism, and allowing the authenticated user to access one or more other network domains of the ubiquitous network based upon the authenticating for the one particular network domain.

### CROSS REFERENCE TO RELATED APPLICATION

Pursuant to 35 U.S.C. § 119(a), this application claims the benefit of earlier filing date and right of priority to Korean Application No. 10-2005-0087462, filed Sep. 20, 2005, the contents of which are hereby incorporated by reference herein in their entirety.

### BACKGROUND OF THE INVENTION

1. Field of the Invention

The present invention relates to a practical security protocol model for ubiquitous networks which is computationally fast and requires low memory resources.

2. Description of the Background Art

Ubiquitous networking represents the availability of pervasive computing and communication resources. On the other hand, so-called “Ambient Networks” are based on AII-IP for emerging 4G systems, consisting of multiple networks from different network operators with differing access technologies. This leads to the trends of increasing ubiquitous network communications as the users have the freedom to choose the access technologies, applications and services. There are also the methods of enhancing the usage of mobile devices and computers, by making them available throughout the physical environment, and effectively invisible to the users. Due to the dynamism of ubiquitous communications, there exist numerous threats, for example, a hacker can gain control of users' devices, eavesdropping of communications channels, modification of sensitive m-commerce transactions, Denial of Service (DoS), transaction of services or goods in other party's identities, etc. Therefore, one must not only provide the safeguards and counter-measures from these threats but also to develop security applications in an increasingly interconnected ubiquitous networks, where there is continuous, seamless use of wireless networking and broadband technologies. In addition, secure communications with anyone, any organizations, anytime, anywhere, using any networks and any device (A6) have to be accomplished.

### BRIEF DESCRIPTION OF THE INVENTION

Security for a ubiquitous network can be provided by detecting a user joining one particular network domain of the ubiquitous network, authenticating the joined user by employing symmetric key authentication together with a single sign-on mechanism, and allowing the authenticated user to access one or more other network domains of the ubiquitous network based upon the authenticating for the one particular network domain.

Here, the symmetric key authentication may employ time stamp information and nonce information, and the single sign-on mechanism can comprise a password protection scheme used together with biometrics data confirmation. Also, the allowing step lets the authenticated user to securely use one or more ubiquitous network services that are provided by different ubiquitous network servers which are connected over secure or insecure links. Additionally, the network domains can commonly employ symmetric encryption keys to perform authentication in a computationally fast manner using minimal memory resources.

### BRIEF DESCRIPTION OF THE DRAWINGS

FIG. 1 illustrates a conceptual ubiquitous network environment.

FIG. 2 illustrates a security environment for ubiquitous environments.

FIG. 3 illustrates an overview of a proposed security model in ubiquitous networks according to the present invention.

FIG. 4 illustrates an overview of a proposed inter-domain security model in ubiquitous networks according to the present invention.

FIG. 5 illustrates an exemplary structure of a mobile communications terminal that implements the proposed security model of the present invention.

### DETAILED DESCRIPTION OF THE INVENTION

Reference will now be made in detail to some embodiments regarding the security of ubiquitous networks in accordance with the present invention, examples of which are illustrated in the accompanying drawings.

Emerging ubiquitous networks will enable interactions between various types of devices, in both wired and wireless networks, and among peer-to-peer (P2P) overlay networks. Dynamic, heterogeneous and distributed P2P overlay networks will help to create new ubiquitous services, through the convergence of communication technologies and highly adaptive re-configurable devices. The present invention provides a practical security protocol model for ubiquitous networks which is computationally fast and requires low memory resources. The present invention combines both a network authentication technique based on symmetric keys and a single sign-on mechanism. The present invention is also able to fully satisfy the security requirements for users of the network applications and services in Ambient Networks.

Basically, the security challenge requirements of ubiquitous networks consist of two categories: general and specific.

A. General Security

General security requirements include (1) confidentiality and integrity, (2) authentication, (3) authorization, and (4) non-repudiation.

Confidentiality and integrity is a service to ensure authorized access of information. Ubiquitous network management information needs to be protected in storage and during transmission. One such protection is through a password. Other protection could be done through the use of a cryptographic hash of a file's contents as the key during the storage and retrieval of the file.

Authentication is the most important of all security services, as it allows one entity to verify the identity of another entity. Mutual authentication is required in ubiquitous networks. Thus, mutual authentication protocols are required to prevent man-in-the-middle for User-to-Device (U2D), Device-to-Device (D2D), Device-to-Network (D2N), and User-to-Service-Provider (U2S) authentications.

Authorization is the process of giving a ubiquitous network device the permission to execute tasks and assign user's access rights on that device. For ‘home’ devices, ubiquitous network environment authorization corresponds to the user's access rights on particular devices. For ‘foreign’ devices, the owner of the device delegates certain access rights to foreign users who will need to pay for the use of these foreign devices in most cases.

Non-repudiation is a service that prevents an entity from denying previous commitments or actions.

B. Specific Security

Specific security requirements include (1) interoperability with local security solutions, (2) availability of ubiquitous network management, (3) protection, revocation, and renewal of credentials, (4) delegation, (5) platform protection, (6) single sign-on, and (7) content protection.

Regarding interoperability with local security solutions, ubiquitous networks comprise of devices in different security domains. Each domain has local security solutions but it is doubtful that they will be well matched with security solutions in other domains and at the ubiquitous network level. Since these local security solutions are very difficult to be altered, the security for ubiquitous network architecture needs to be compatible with existing local security solutions.

Regarding availability of ubiquitous network management functions, ubiquitous networking is a very dynamic self-adapting environment with devices joining and leaving the networks. If a device behaved as a gateway to a sub-network, it will affect the entire sub-network when it leaves. As the ubiquitous network environment requires to be in proper operation despite these dynamic changes, Ubiquitous Device Management (UDM) functions to maintain such operation need to be globally available.

Regarding the protection, revocation, and renewal of credentials, ubiquitous network user's credentials exist at different layers. For example, these credentials can exist at the link layer for wired and wireless communications, and IP (and IPSec) at the network layer. At the transport layer, SSL/TLS security protocols could be embedded. The ubiquitous network user credentials also exist at the ubiquitous network overlays, above the transport layer, but below the application layer (middleware layer where the user services run). Of course, all these credentials need to be adequately protected, and the protocols put in place for their revocation and renewal. In addition, it should be remembered that depending on the technology, the end points of the security associations may differ. Different security protocols exist in the different sub-networks of the ubiquitous network infrastructure; uniform protocols are required at the ubiquitous network level. These protocols unify the existing solutions of a heterogeneous and dynamic environment.

Regarding delegation, ubiquitous networking has environments that engage numerous devices and services running on these devices on behalf of the ubiquitous network users. Because of the self-adapting characteristics of ubiquitous networking, a service could change the device or the entire sub-network where it is running, for example, a device moves from a car network environment into the home network environment. It is very complicated for ubiquitous network users to authorize all these changes and therefore it is necessary that the users delegate their rights to a management function acting on their behalf by using mobile agents.

Regarding platform protection, a major motivation behind the development of ubiquitous networking is the ability to download applications securely to the ubiquitous network devices, and allowing the ubiquitous network devices to be reconfigured in a secured manner. Since the goal of the ubiquitous network devices is to give access to a vast variety of services, if restrictions are not placed on the source of downloaded applications, then there is a risk that malicious applications may reconfigure a device in an unauthorized manner. Therefore, it is important to provide some form of Secure Mobile Execution Environment (SMExE) to protect the platform from such attacks.

Regarding single sign-on, ubiquitous networks interoperate with other existing environments, each of which has a specific authentication infrastructure in place. Since the users need to authenticate different devices, networks, and service, all acting in different roles, it is necessary to implement a single sign-on solution. This will allow users to authenticate only once to initiate ubiquitous networks seamless operations in all network domains. This allows the ubiquitous users to leave and join the ubiquitous networks without any interruptions.

Regarding content protection, significant driving force behind the development of ubiquitous networking is the capability to deliver new services to ubiquitous network users. It is foreseen that a considerable number of these services will engage the provisioning and delivering of next-generation DMB (Digital Multimedia Broadcasting) mobile content to end users. As the digital nature of such digital content allows perfect copies to be made, content providers are naturally concerned that their copyrights be protected. For ubiquitous network environments to fully exploit the potential access to DMB mobile content, some forms of Digital Rights Management (DRM) system will be required to be implemented in ubiquitous network devices.

Regarding the security characteristics of ubiquitous networks, there are (a) heterogeneous characteristics, (b) dynamic and self-organizing characteristics, and (c) privacy and trust characteristics. There exist numerous threats that are difficult to track and secure in ubiquitous networks, for example, a hacker gaining control of user devices, eavesdropping of communication channels, modification of sensitive m-commerce transactions, DoS, transaction of services or goods in other identities, etc. in differing and seamless network environments. Thus, ubiquitous network infrastructure will require the provision of a certain degree of security between participating user devices.

Regarding heterogeneous characteristics, one of the most important objectives of the ubiquitous network infrastructure is to allow interconnection of wired and wireless networks, so that services and applications are accessible in any network. Attacks by malicious nodes in any network can happen. An example of such an attack is a DoS attack, which corrupts application-level communications by giving an erroneous response to request and mis-route traffic. Therefore, the challenge is to prevent DoS attacks by incorporating appropriate security protocols and managing credentials in a manner that end-to-end security is achieved from the user's perspective, as unobtrusively as possible.

Regarding dynamic and self-organizing characteristics, a major motivation for ubiquity is to allow ubiquitous network users to obtain a vast variety of services from a wide choice of service providers. Thus, there exist many services that could be supplied on demand, with security policies enforced. These services could be utilized by a variety of different ubiquitous network user devices. Thus, the Quality of Service (QoS) levels that are available to ubiquitous network users will depend upon the locations and the processing resources available at a certain specific time. As ubiquitous users travel from one network to other networks, security must be reconfigured dynamically because the ubiquitous network user's network environment may change when they join, leave, or re-join the networks. Moreover, the security threats imposed by one network differ from other networks. Thus, due to this dynamism, ubiquitous network user devices will require computationally fast authentication and an authorization security protocol to be devised, as they join, leave and re-join the ubiquitous network.

Regarding privacy and trust characteristics, different degrees of trust may be required for different users and their devices to access services in ubiquitous networks. These will be reflected in the ubiquitous network record and resources to determine whether the users and their devices are authorized to access. Applications that are implemented must be trusted to operate correctly and have full privileges to access the resources of the network and devices. Trust models that are based on real world and social properties to identify trustworthy entities and to develop the capability to reason about trust are required in ubiquitous networks. Thus, the security architecture for the ubiquitous network environment should be designed to allow safe execution of trusted applications in real world and social scenarios.

With the current usage of 3G communications systems and wireless LAN technologies (WiFi), it is clear that future mobile devices will require access to an increasing number of services. An immense potential exists to provide these services to a variety of ubiquitous computing devices using a range of communications technologies.

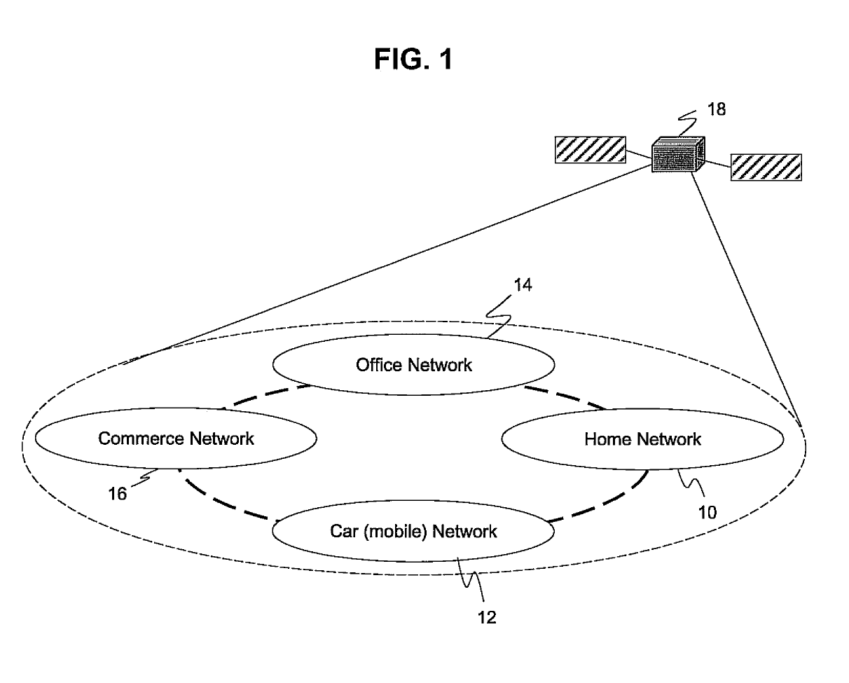

As shown in FIG. 1, some of these devices could be linked to for Wireless Personal Area Networks (WPANs), allowing the users to have access to home, car, office, and commerce networks (10, 12, 14, 16) that may be within a coverage area of a GPS satellite 18. Considering the wireless personal networking concept, we could envision an infrastructure to allow interaction between personal devices using a wide range of ubiquitous communications technologies. The availability of Peer-to-Peer (P2P) overlay network environments will also enable wider access to on-demand services, creating overlays of ubiquitous networks. This has apparent benefits to the consumers, the network operators, and the service providers. Thus, there is a need to work towards the development of secure ubiquitous applications and provisioning of a secure environment to operate on.

The basic concept of ubiquitous networking is regarded to be founded on the belief that future ubiquitous telecommunications systems will allow heterogeneous wired and wireless access to a vast range of services. As a result, many collaboration networks are created, such as the Mobile Ad hoc P2P (MAP2P) network, which forms self-organizing P2P infrastructures. The ubiquitous network can associate with multiple user devices accessing multiple services through different networks. This situation somewhat resembles the UST WSI Project concept of a “MultiSphere”, where the user has access to many different user devices interlinked by a number of gateways.

The coverage of the ubiquitous network is not inevitably widespread but could take place in small coverage areas or islands. These may or may not be interlinked by clusters of cooperating networks. Thus, a specific session may not be seamless but is established or continued whenever the user is within the coverage of the service delivery mechanisms. These delivery mechanisms could comprise of Digital Multimedia Broadcast (DMB) networks, wireless networks, or personal MAP2P networks.

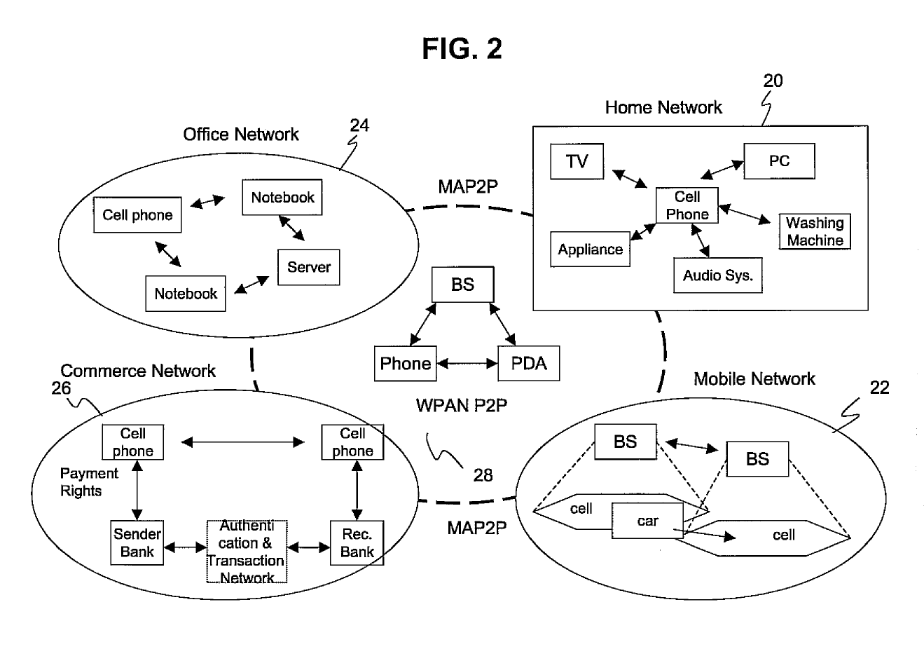

As shown in FIG. 2, the devices grouping in MAP2P are diverse and originated from different ubiquitous computing environments that users have associated with, namely, the office environment (24) (e.g., remote access control, corporate Intranet, etc.), the home environment (20) (e.g., home PC, consumer electronics, Set-Top Boxes (STB), home gateways, etc.), the vehicle or mobility environment (22) (e.g., car networks, DMB systems, navigation systems, etc.), the commerce environment (26), and the personal (WPAN) environment (28) (e.g., mobile devices, Pocket PC, WiFi laptop, etc.).

For example, a user of the ubiquitous network could easily configure a home server or STB in the home network to monitor schedules for selecting a movie of choice. When the user is traveling, he is able to receive a message forwarded by the STB about a selected movie that will be started to be shown. He user may receive this message through Multimedia Messaging Service (MMS) provided by 3G or IEEE 802.11/802.15 systems. The user could send an instruction to the home server (or STB) to transmit the movie to him via the ubiquitous network infrastructures. Such delivery of service is provided by different network infrastructures that are interconnected, so that the user would continue to enjoy the service seamlessly, without any interruptions. To capitalize on this trend described, “structured” or “unstructured” P2P overlays may be built to create a self-organizing MAP2P substrate. These overlay networks form part of the ubiquitous networking infrastructure that are scalable, self-organizing, and fault-tolerant and provide effective load-balancing.

The motivation for the security protocol proposal of the present invention for a Ubiquitous-to-Ubiquitous User (referred to as a “U3 user” hereafter) is that the U3 users and devices, once authenticated in a computationally fast manner, will have seamless and secured access in all roaming network domains (e.g., home, office, vehicle, WPAN network environments). Namely, a U3 user will be able to securely use one or more ubiquitous network services that are provided by different ubiquitous network servers which are connected over insecure networks.

Here, it is assumed that all the devices that belong to one particular network domain have been securely bootstrapped with the ubiquitous network server within that network domain. The present invention security protocol is based on the enhanced version of the Kerberos scheme (as described in “The Kerberos Network Authentication Service,” J. Kohl and C. Neuman, Network Working Group Request for Comments: 1510, Tech. Rep., September 1993), which is based on symmetric key cryptography, and key management can be based on trust relationships (as described in “Trust-based Security in Pervasive Computing Environments,” IEEE Computer, vol. 24, no. 12, pp. 154-157, December 2001).

Conceptually, the Kerberos scheme is simple with its fundamental components of tickets and session keys. To prove one's identity to others, one must first obtain a ticket from a centralized authority and then presents the obtained ticket. In Kerberos, this authority is known as the Key Distribution Center (KDC), and this service is implemented in each network domain controller. It should be noted that the Kerberos scheme merely pertains to a client-server security protocol within a single network. However, the present invention pertains to a security protocol between not only a client and a server, but also between different network domains (each having at least one server), while considering the mobility characteristics of users that may join, leave, and re-join one or more network domains. As such, the Kerberos scheme cannot be simply applied to a ubiquitous network environment, because the technical considerations involved in handling the mobility of users travelling between different network domains need to be addressed when providing a security protocol for such users. Thus, the present invention improves the Kerberos network authentication technique by employing the features of a time stamp and a nonce (i.e., a non-repeating identifier), which are combined with a single sign-on mechanism (e.g., biometrics) for all roaming network domains.

The advantage of using symmetrical key authentication is that it is computationally faster than the asymmetric/public key algorithm. Most U3 mobile devices are small, with limited computational capabilities and memory resources. This places stringent constraints on the cryptographic primitives deployed for these devices in ubiquitous networks. Storing and performing operations with long cryptographic keys so as to ensure realistic security will be resource draining. These devices may require its memory to be shared by the device operating system and applications in ubiquitous networks. As a result, this leaves the devices with little memory for implementing many of the commonly available cryptography primitives. Under these constraints, asymmetric cryptography may be difficult to implement, and symmetric cryptography is a more feasible option which uses smaller key size and is orders of magnitude faster in terms of computation speed. With this computationally fast secured environment, U3 users can easily roam from one ubiquitous network domain to another, and they can join or leave the communication sessions seamlessly with minimal computational resources.

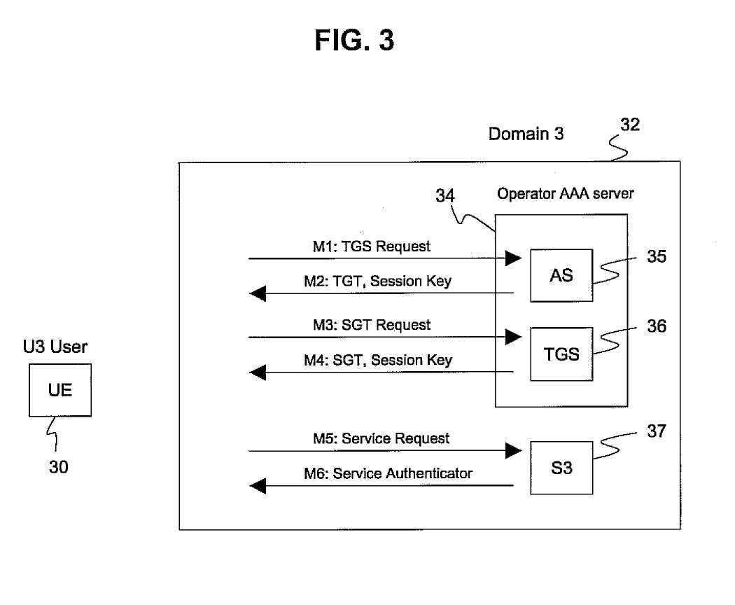

FIG. 3 illustrates an overview of the security model and algorithmic description of the present invention comprising a mobile terminal (30), a domain 3 (32), an operator AAA server (34), an Authentication Server (AS) (35), a Ticket Granting Server (TGS) (36), and a service server (37). Basically, there are three stages of securing user and application access in ubiquitous networks, namely, authentication, access control and key negotiation, which will be described in more detail below.

(1) Authentication Stage

U3 users first authenticate themselves to an Authentication Server (AS) by using single sign-on techniques that will issue U3 users with a temporary permit to request access to services. This permit is called a Ticket-Granting Ticket (TGT) and is comparable to a passport with a limited duration of validity period (lifetime).

(2) Access Control Stage

Each U3 user uses the TGT in a second stage to receive a service-specific access authorization, for example, it can be used to access servers S₁, S₂, . . . , S_{N} that offer network services. The Ticket Granting Server (TGS) verifies that each U3 user is authorized to have access to the service requested and it responds with a Service Granting Ticket (SGT) for servers S₁, S₂, . . . , S_{N}.

(3) Key Negotiation Stage

The AS generates a session key for communication between U3 users and the Ticket Granting Server (TGS). The TGS generates a corresponding session key for communication between U3 users and the service-specific servers.

The procedures of FIG. 3 can be explained in more detail as follows:

In step 1, the user logs into his mobile device and requests access to a particular service. The mobile device sends a first message M1 with the user's time stamp T_{U3} and nonce N_{U3}, which can be expressed as:
M1:U3→AS:(U3, TGS, T_{U3}, N_{U3}).

In step 2, the AS verifies from its user database that it knows of the user (U3). From the user's biometrics data (e.g., scanned fingerprints, voice and face recognition implemented together with password protection), that is also stored in the user database, a symmetric key (K_{U3}) is generated. Then, the AS extracts the identities, such as the IP address and MAC address of the user device (ID_{U3}) from a user protocol data unit that is received. The AS then creates a ticket (Ticket_{TGS}) and a session key (K_{U3,TGS}) and sends a second message (M2) to the user (U3), which can be expressed as:
M2:AS→U3:E_{KU3}(K_{U3,TGS}, TGS, N_{U3}, T_{AS}, L_{TGS}, Ticket_{TGS}),

whereby E_{K} refers to an encryption by using a symmetric key K, Kₓ refers to x's secret key, K_{x,y} refers to a session key for x and y, and L is the lifetime (validity period) of Ticket_{TGS}, which is defined as:
Ticket_{TGS}=E_{AS,TGS}(K_{U3,TGS}, U3, ID_{U3}, TGS, T_{AS}, L_{TGS}).

In step 3, upon receipt of M2, the mobile device (or devices) request the user to enter biometric data together with their password. These are used to compute the symmetric key K_{U3} so that the mobile device can decrypt the message. If the user did not enter the correct password, the key K_{U3} will not be computed correctly and consequently it will fail. Finally, the user (mobile device) generates an Authenticator that is sent together with the TGT and the name of the desired server (S₁, S₂, . . . , S_{N}) to the TGS, which can be expressed as:
M3:U3→TGS:(S₃, Ticket_{TGS}, N′_{U3}, Authenticator_{U3,TGS}),

whereby Authenticator_{U3,TGS}=E_{KU3,TGS}(U3, ID_{U3}, T′_{U3}, N′_{U3}), the T′_{U3} is a time stamp generated by the user (U3) and the same mobile terminal at that particular time instance, and N′_{U3} is a nonce (i.e., a non-repeating identifier) that is generated by the same mobile terminal at a different time instance.

In step 4, after the TGS decrypts the Ticket_{TGS}, a session key K_{U3,TGS} is obtained and is used to decrypt the Authenticator_{U3,TGS}. Thereafter, the TGS verifies the user name and time stamp. If these procedures are successful, the U3 user will be granted access rights to the server (e.g., S₃). A time stamp of T_{TGS}, a session key K_{U3,S3}, and a ticket Ticket_{S3} are generated for access to server S₃. The TGS can then send the following message M4 to the U3 user(s).
M4:TGS→U3:E_{KU3,TGS}(K_{U3,S3}, S₃, N_{U3}, T_{TGS}, Ticket_{S3}),

whereby Ticket_{S3}=E_{KU3,S3}(K_{U3,S3}, U3, ID_{U3}, S₃, T_{AS}, L_{S3}).

In step 5, the U3 user decrypts M4 and obtains a session key for performing secure communications with server S₃. The U3 user generates a new Authenticator and sends it together with the U3 user's ticket to S₃ as follows:
M5:U3→S3:(Ticket_{S3}, Authenticator_{U3,S3}),

whereby Authenticator_{U3,S3}=E_{KU3,S3}(U3, ID_{U3}, T′_{U3}).

In step 6, the server S₃ decrypts the received ticket using key K_{TGS,S3}, and obtains session key K_{U3,S3}. Then, the server S₃ uses this key to verify the Authenticator and sends message M6 to the U3 user(s) as follows:
M6:S₃→U3:E_{KU3,S3}(T′_{U3}+1).

In step 7, the U3 user then decrypts this message (M6) and verify the time stamp incremented by one. If these processes were successful, the U3 user would need to establish secure communications with only one server S₃ but not with the TGS.

The security protocol of the present invention explained above, can be extended for inter-domains authentication. For example, U3 users with access to server S3 can also access services in other network domains at different locations (S₁, S₂, . . . , S_{N}).

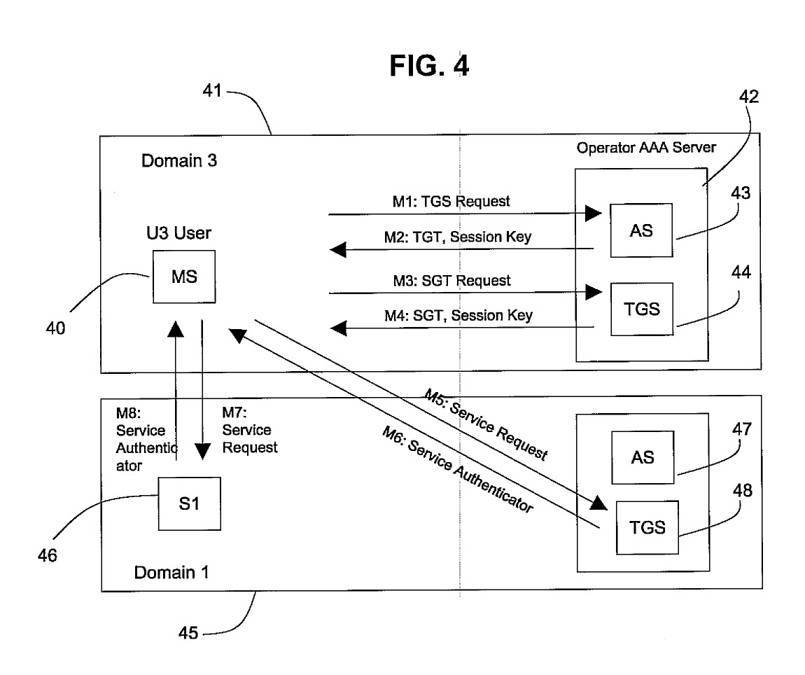

FIG. 4 illustrates the extension proposal of the above explained basic security protocol for inter-domain communications, having a domain 3 (41) with a mobile terminal (40) and an operator AAA server (42) including a AS (43) and a TGS (44), and a domain 1 (45) with a server (S1) (46), a AS (47) and a TGS (48). Inter-domain authentication requires two TGSs each belonging to different network domains to have a path of trust established from one network domain to another network domain, and they must have agreed secret keys, such as K_{TGS3, TGS1} for TGS₃ and TGS₁ in network domain 3 and 1, respectively. According to the inter-domain security protocol, the local TSG₃ for server S₃ views the remote TGS₁ for server S₁ as a “remote roaming” server and thus TGS₃ can issue a ticket for TGS₁.

After the U3 user obtains a Ticket_{TGS1} for the remote network domain 1, the U3 user sends a request to the remote TGS₁ in remote network domain 1, and the TGS₁ proceeds to issue the U3 user with a Ticket_{S1} for the establishment of secure communications with the requested server S1, as described in the above algorithm steps. It is vital to note that the remote network domain trusts the AS of the local domain, as the remote AS does not perform their own authentication check of the visiting U3 users. Thus, with the proposed security protocol for ubiquitous network access, a computationally fast and uniform credentials may be achieved securely and seamlessly.

The present invention security model uses symmetric algorithms to secure communications in ubiquitous networks. Such authentication mechanism is computationally fast. The present invention can further minimize hacking (such as password guessing) by implementing biometrics data (“what you are”) together with password protections (“what you know”). The present invention improves the known Kerberos scheme by including a time stamp and a nonce, combined with a single sign-on mechanism. The time stamp and nonce are introduced for the freshness of the message in the ubiquitous network environment, which can prevent a reply attack from occurring. Due to the possibility that the time stamp requires synchronized clocks for communication between both ends, an additional counter measure, namely a nonce, is also introduced. Additionally, the present invention security model prevents passive and active attackers who may impersonate other identities when accessing ubiquitous services in different network domains, by using tickets and session keys to confer identity ownership. Such inter-domain security protocol can be easily implemented in the existing Authentication, Authorization and Accounting (AAA) servers and the Authentication Dial-In User Service (RADIUS) provided by the existing mobile operators' network infrastructure, allowing access to differing ubiquitous network services in these network domains.

Ambient Intelligence, developed by the IST EU 6^{th} Framework Program (FP6) research effort within the Wireless World Initiative (WWI), has the major goals of defining an affordable and computationally fast 4G ubiquitous networks that opens up ways to securely communicate with others. Within this framework, the Ambient Networks are based on all-IP based 4G networks and also adopted IPv6. In addition, all-IP based 4G networks can easily use Ambient Networking Services. It is geared towards supporting multimedia traffic, total mobility in ubiquitous networks, and a variety of wireless access technologies. Ambient Networks also aim to provide a domain-structured, peer-to-peer view for network control so that it is expected to accommodate the heterogeneity arising from the different network control technologies. It is designed to appear to be homogeneous to the users of the network applications and services. Hence, the security protocol model for ubiquitous networks according to the present invention can also fully satisfy the security requirements of Ambient Networks.

Emerging ubiquitous communication systems will enable interaction between increasingly diverse ranges of devices that are Internet-enabled and based on all-IP configurations. This will allow users to use ubiquitous services using a combination of different communication technologies in various network domains. Dynamic, heterogeneous and distributed networks will create new opportunities through the convergence of communications technologies and creation of highly adaptive reconfigurable devices. However, increased mobility results in various types of security challenges.

The present description discusses various security characteristics and challenges for ubiquitous networks and attempts to define a seamless security protocol model based on a single sign-on mechanism and a computationally fast network authentication technique. The objective of such security model is to define a global and seamless security architecture which addresses various security requirements for ubiquitous networks with different access technologies in various network domains. Although the above-described present invention achieves this objective, further improvements and enhancements, which would involve addressing delegation and revocation issues in access control rights, can be considered.

For services requiring public key cryptography (e.g., non-repudiation and key escrow), deployment of asymmetric encryption techniques, such as digital signatures in ubiquitous networks, requires a significant amount of computing resources and may be infeasible or uneconomical to implement such mutual authentication services between mobile devices in ubiquitous networks. Symmetric/secret key cryptography employs shared secret keys, but this is problematic because it is difficult to get started (i.e., Alice needs to go see Bob before she can send him a secret message), hard to scale (i.e., if Alice wants to send a message to Carol, she has to start over with a new secret), and an oxymoron (i.e., if Alice and Bob both have the secret key, Alice has to trust Bob completely). In contrast, asymmetric/public key cryptography has the advantage of no shared secret keys. Thus, it would be more favorable to develop hybrid and lightweight asymmetric and symmetric key techniques for the ubiquitous network environment, whereby asymmetric key cryptography can be used to solve the key distribution problem and symmetric key cryptography can be used to encrypt bulk data. Lightweight asymmetric techniques, such as ID-based crypto-systems could provide intelligent facilities for securing applications in inter-domain network environments, as well as securing military applications. ID-based systems require no explicit public key available and the key is constructed from publicly available information. In an asymmetric system, the unique user names play the role of the public key. Thus, such characteristics of ID-based techniques make it very suitable for a global ubiquitous network security architecture.

The present invention provides a method of gaining secure access to a ubiquitous network, the method comprising: joining one particular network domain of a ubiquitous network; receiving authentication from the one particular network domain upon performing symmetric key authentication together with a single sign-on procedure; and accessing one or more other network domains of the ubiquitous network based upon the received authentication for the one particular network domain.

Here, the symmetric key authentication can employ time stamp information and nonce information. The single sign-on procedure can comprise a password protection scheme used together with user biometrics data confirmation. The authentication can allow secure use of one or more ubiquitous network services that are provided by one or more ubiquitous network servers which are connected over secure or insecure communication links. The network domains can commonly employ symmetric encryption keys to perform authentication in a computationally fast manner using minimal memory resources.

Also, the present invention provides a method of gaining secure access to a ubiquitous network, the method comprising: an authentication stage where a user performs a single sign-on procedure to authenticate himself to an authentication server (AS1) that issues a temporary permit (TGT) allowing the user to request access to a network service; an access control stage where the user uses the temporary permit to receive access authorization for a specific network service provided by a network service server (S1 or S2), and receives a Service Granting Ticket allowing the user to access the network service server after a first access server (TGS1) verifies that the user is authorized to have access to the requested network service; and a key negotiation stage where the user receives a session key generated by the authentication server (AS1) to allow communication between the user and the first access server, and receives a corresponding session key generated by the first access server (TGS1) to allow communication between the user and the network service server (S1 or S2).

Here, the authentication server, the first access server, and the network service server can be part of the same network domain (D1), and the Service Granting Ticket is provided by the first access server (TGS1). The access control stage can further comprises: receiving the Service Granting Ticket from a second access server (TGS2), wherein the second access server and the network service server (S2) are part of a different network domain (D2) than that of the first access server (D1). The key negotiation stage can further comprises: receiving another corresponding session key generated by the second access server (TGS2) to allow communication between the user and another network service server (S2). The authentication server and the first access server can be part of an operator Authentication, Authorization and Accounting server. The temporary permit can be a Ticket Granting Ticket (TGT) having a limited duration of validity. The authentication stage can employ symmetric key authentication using time stamp information and nonce information. The single sign-on procedure can comprise a password protection scheme used together with user biometrics data confirmation. The first and second access servers (TGS1, TGS1) can have a trusted communications path established between their respective network domains. The first and second access servers (TGS1, TGS1) can respectively have agreed secret keys.

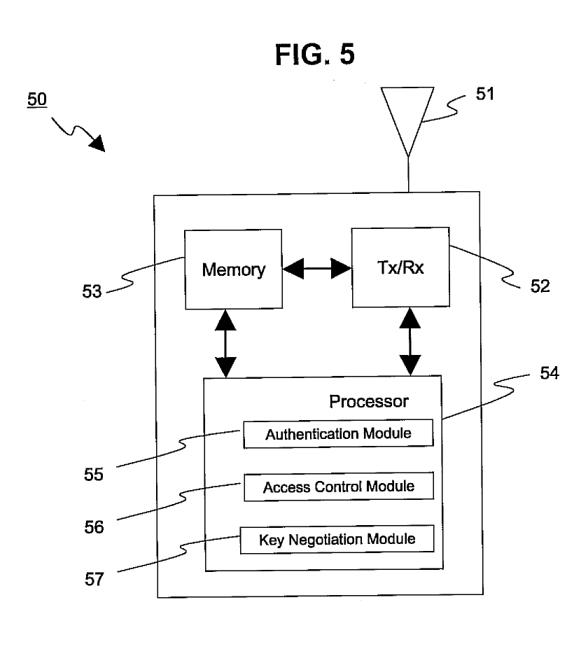

As shown in FIG. 5, the present invention also provides a mobile terminal (50) comprising: a transceiver (52) to perform communication with a ubiquitous network; a memory (53) having stored therein a security protocol (55, 56, 57) to allow the communication to be performed securely; a processor (54) adapted to cooperate with the transceiver and the memory such that the security protocol (55, 56, 57) is used to perform the steps of, joining one particular network domain of a ubiquitous network; receiving authentication from the one particular network domain upon performing symmetric key authentication together with a single sign-on procedure; and accessing one or more other network domains of the ubiquitous network based upon the received authentication for the one particular network domain.

Also, the present invention provides a mobile terminal (50) comprising: a transceiver (52) to perform communication with a ubiquitous network; a memory (53) having stored therein a security protocol (55, 56, 57) to allow the communication to be performed securely; a processor (54) adapted to cooperate with the transceiver and the memory such that the security protocol is used to perform the steps of, an authentication stage (55) where a user performs a single sign-on procedure to authenticate himself to an authentication server (AS1) that issues a temporary permit (TGT) allowing the user to request access to a network service; an access control stage (56) where the user uses the temporary permit to receive access authorization for a specific network service provided by a network service server (S1 or S2), and receives a Service Granting Ticket allowing the user to access the network service server after a first access server (TGS1) verifies that the user is authorized to have access to the requested network service; and a key negotiation stage (57) where the user receives a session key generated by the authentication server (AS1) to allow communication between the user and the first access server, and receives a corresponding session key generated by the first access server (TGS1) to allow communication between the user and the network service server (S1 or S2).

Here, it should be noted that the security protocol of the present invention can be implemented in hardware, software, and/or any combination thereof. For example, the microprocessor (54) may consist of a authentication module (55), a access control module (56), and a key negotiation module (57).

It can be understood that the present invention would have a wide variety of practical applications. For example, the security protocol model of the present invention may be implemented together with telematics technology, to allow a user who is driving on the road to travel into and out of various types of network domains while having a secure and seamless communication connections with different network servers. Also, although wireless and mobile communication technologies will continue to develop such that network capacity and data throughput will increase, the present invention can nonetheless still be applicable to such developing and future technologies, as secure and seamless connections would still be necessary. Examples of future improvements may include the so-called power line communications (PLC) technology that permits network connections (such as Internet browsing) to be made through power outlet plugs by allowing data signals to be sent and received over power lines, which will further improve home networking and allowing continued development of ubiquitous network technologies. Also, as fourth generation (4G) communications technologies continue to develop, the features of the present invention can be implemented in various types of ubiquitous networks and convergence networks.

As the present invention may be embodied in several forms without departing from the spirit or essential characteristics thereof it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method of gaining secure access to a ubiquitous network, the method comprising:
joining one particular network domain of a ubiquitous network;
receiving authentication from the one particular network domain upon performing symmetric key authentication together with a single sign-on procedure; and
accessing one or more other network domains of the ubiquitous network based upon the received authentication for the one particular network domain.

2. The method of claim 1, wherein the symmetric key authentication employs time stamp information and nonce information.

3. The method of claim 1, wherein the single sign-on procedure comprises a password protection scheme used together with user biometrics data confirmation.

4. The method of claim 1, wherein the authentication allows secure use of one or more ubiquitous network services that are provided by one or more ubiquitous network servers which are connected over secure or insecure communication links.

5. The method of claim 1, wherein the network domains commonly employ symmetric encryption keys to perform authentication in a computationally fast manner using minimal memory resources.

6. A method of gaining secure access to a ubiquitous network, the method comprising:
an authentication stage where a user performs a single sign-on procedure to authenticate himself to an authentication server (AS1) that issues a temporary permit (TGT) allowing the user to request access to a network service;
an access control stage where the user uses the temporary permit to receive access authorization for a specific network service provided by a network service server (S1 or S2), and receives a Service Granting Ticket allowing the user to access the network service server after a first access server (TGS1) verifies that the user is authorized to have access to the requested network service; and
a key negotiation stage where the user receives a session key generated by the authentication server (AS1) to allow communication between the user and the first access server, and receives a corresponding session key generated by the first access server (TGS1) to allow communication between the user and the network service server (S1 or S2).

7. The method of claim 6, wherein the authentication server, the first access server, and the network service server are part of the same network domain (D1), and the Service Granting Ticket is provided by the first access server (TGS1).

8. The method of claim 6, wherein the access control stage further comprises:
receiving the Service Granting Ticket from a second access server (TGS2), wherein the second access server and the network service server (S2) are part of a different network domain (D2) than that of the first access server (D1).

9. The method of claim 8, wherein the key negotiation stage further comprises:
receiving another corresponding session key generated by the second access server (TGS2) to allow communication between the user and another network service server (S2).

10. The method of claim 6, wherein the authentication server and the first access server are part of an operator Authentication, Authorization and Accounting server.

11. The method of claim 6, wherein the temporary permit is a Ticket Granting Ticket (TGT) having a limited duration of validity.

12. The method of claim 6, wherein the authentication stage employs symmetric key authentication using time stamp information and nonce information.

13. The method of claim 6, wherein the single sign-on procedure comprises a password protection scheme used together with user biometrics data confirmation.

14. The method of claim 8, wherein the first and second access servers (TGS1, TGS1) have a trusted communications path established between their respective network domains.

15. The method of claim 14, wherein the first and second access servers (TGS1, TGS1) respectively have agreed secret keys.

16. A mobile terminal comprising:
a transceiver to perform communication with a ubiquitous network;
a memory having stored therein a security protocol to allow the communication to be performed securely;
a processor adapted to cooperate with the transceiver and the memory such that the security protocol is used to perform the steps of,
joining one particular network domain of a ubiquitous network;
receiving authentication from the one particular network domain upon performing symmetric key authentication together with a single sign-on procedure; and
accessing one or more other network domains of the ubiquitous network based upon the received authentication for the one particular network domain.

17. The mobile terminal of claim 16, wherein the symmetric key authentication employs time stamp information and nonce information.

18. The mobile terminal of claim 16, wherein the single sign-on procedure comprises a password protection scheme used together with user biometrics data confirmation.

19. The mobile terminal of claim 16, wherein the authentication allows secure use of one or more ubiquitous network services that are provided by one or more ubiquitous network servers which are connected over secure or insecure communication links.

20. The mobile terminal of claim 16, wherein the network domains commonly employ symmetric encryption keys to perform authentication in a computationally fast manner using minimal memory resources.

21. A mobile terminal comprising:
a transceiver to perform communication with a ubiquitous network;
a memory having stored therein a security protocol to allow the communication to be performed securely;
a processor adapted to cooperate with the transceiver and the memory such that the security protocol is used to perform the steps of,
an authentication stage where a user performs a single sign-on procedure to authenticate himself to an authentication server (AS1) that issues a temporary permit (TGT) allowing the user to request access to a network service;
an access control stage where the user uses the temporary permit to receive access authorization for a specific network service provided by a network service server (S1 or S2), and receives a Service Granting Ticket allowing the user to access the network service server after a first access server (TGS1) verifies that the user is authorized to have access to the requested network service; and
a key negotiation stage where the user receives a session key generated by the authentication server (AS1) to allow communication between the user and the first access server, and receives a corresponding session key generated by the first access server (TGS1) to allow communication between the user and the network service server (S1 or S2).

22. The method of claim 21, wherein the authentication server, the first access server, and the network service server are part of the same network domain (D1), and the Service Granting Ticket is provided by the first access server (TGS1).

23. The method of claim 21, wherein the access control stage further comprises:
receiving the Service Granting Ticket from a second access server (TGS2), wherein the second access server and the network service server (S2) are part of a different network domain (D2) than that of the first access server (D1).

24. The method of claim 23, wherein the key negotiation stage further comprises:
receiving another corresponding session key generated by the second access server (TGS2) to allow communication between the user and another network service server (S2).

25. The method of claim 21, wherein the authentication server and the first access server are part of an operator Authentication, Authorization and Accounting server.

26. The method of claim 21, wherein the temporary permit is a Ticket Granting Ticket (TGT) having a limited duration of validity.

27. The method of claim 21, wherein the authentication stage employs symmetric key authentication using time stamp information and nonce information.

28. The method of claim 21, wherein the single sign-on procedure comprises a password protection scheme used together with user biometrics data confirmation.

29. The method of claim 23, wherein the first and second access servers (TGS1, TGS1) have a trusted communications path established between their respective network domains.

30. The method of claim 29, wherein the first and second access servers (TGS1, TGS1) respectively have agreed secret keys.
